(19) United States
(12) Patent Application Publication
(10) Pub. No.: US 2003/0059218 A1
(43) Pub. Date: Mar. 27, 2003

(54) Sensor in car window

(75) Inventors: Kazuki Sakata, Tokyo (JP); Katsuaki Yasui, Tokyo (JP)

Correspondence Address: SUGHRUE, MION, ZINN, MACPEAK & SEAS, 2100 Pennsylvania Avenue, N.W., Washington, DC, 20037, US

(73) Assignee: MITSUBISHI DENKI KABUSHIKI KAISHA

(21) Appl. No.: 10/004,840

(22) Filed: Dec. 7, 2001

(30) Foreign Application Priority Data
Jun. 13, 2001 (JP) 2001-178576

(51) Int. Cl. G03B 17/48

(52) U.S. Cl. 396/429

(57) ABSTRACT

A sensor in a car window prevents dew from being formed only on a lens in a hood thereof and the car window even when temperature changes, and also protects the lens and the car window from contamination by floating particulates, such as cigarette smokes. The sensor in a car window is formed of a camera that has a hood partitioned in consort with the car window from a vehicle compartment area, and a camera main body that includes a lens projecting within the hood and detects, through the lens, an object located in front thereof. A breathable dustproof filter is provided on a part of the hood.

### BACKGROUND OF THE INVENTION

1. Field of the Invention

The present invention relates to a sensor in a car window that includes, for example, a hood partitioned in consort with a car window from a vehicle compartment area, and a camera main body having a lens projecting within the hood.

2. Description of the Related Art

FIG. 2 is a sectional view of a conventional camera in a car window disclosed in Japanese Unexamined Patent Publication No. 11-69211.

The camera in a car window has a hood 2 partitioned in consort with a windshield 1 (a car window) from the area of a vehicle compartment 5, and a camera main body 4 serving as a sensor main body with an imaging lens 3 that projects within the hood 2.

Through the imaging lens 3, the camera in a car window photographs an object to be imaged (an object to be detected) that is located in front of the windshield 1.

The imaging lens 3 of the indoor camera is isolated from the space in the vehicle compartment 5 by the windshield 1 and the hood 2, so that the imaging lens 3 is protected from contamination by dust, especially cigarette smoke particulates, floating in the air in the vehicle compartment 5.

Although the conventional camera in a car window protects the imaging lens 3 from contamination by cigarette smoke or the like, the camera presents a problem caused by changes in the amount of saturated vapor attributed to changes in temperature. To be more specific, the moisture in the air confined in the hood 2 is cooled down to a dew point or lower and turns into dew on the surface of the lens 3 or on the inner surface of the hood 2, and then heated to evaporate. This cooling and heating repeatedly takes place. In particular, if a drop in temperature prevents the moisture in the air confined in the hood 2 from merging into the air, and causes the moisture to be cooled down to the dew point or below and formed into dew on the surface of the lens 3 or the inner surface of the windshield 1, then the dewed portions will be clouded, adversely affecting the photographing.

### SUMMARY OF THE INVENTION

Accordingly, the present invention has been made with a view toward solving the problem described above, and it is an object of the invention to provide a sensor in a car window that prevents dew from being formed only on the lens in a hood and a car window even if temperature changes, and also prevents the lens in the hood and a part of the car window from being contaminated by cigarette smoke or other types of floating particulates.

To this end, according to the present invention, there is provided a sensor in a car window, having a hood partitioned in consort with a car window from a vehicle compartment area, and a sensor main body that includes a lens projecting within the hood and detects, through the lens, an object located in front thereof, wherein a breathable dustproof filter is provided on a part of the hood.

### BRIEF DESCRIPTION OF THE DRAWINGS

FIG. 1 is a sectional side elevation of a camera in a car window according to a first embodiment of the present invention; and

FIG. 2 is a sectional side elevation of a conventional camera in a car window.

### DESCRIPTION OF THE PREFERRED EMBODIMENTS

First Embodiment

In the following description of a camera in a car window that serves as the sensor in a car window in accordance with the present invention, the members or portions that are the same as or corresponding to those of the conventional camera in a car window will be assigned the same reference numerals.

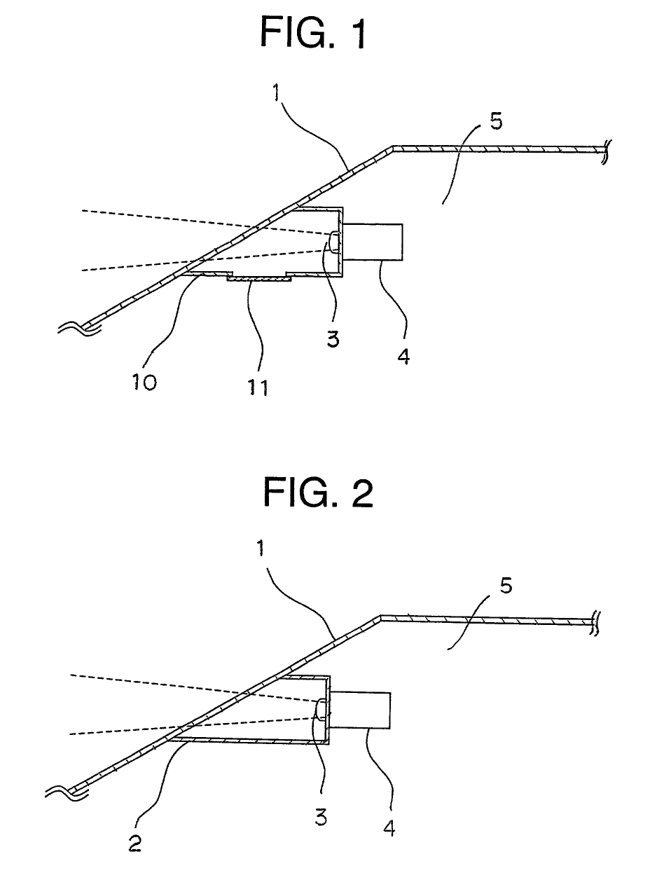

FIG. 1 is a sectional side elevation of a camera in a car window according to a first embodiment. The camera includes a hood 10 partitioned in consort with a windshield 1 (a car window) from the area of a vehicle compartment 5, a camera main body 4 which has a lens 3 projecting within the hood 10 and serves as a sensor main body for imaging an object to be photographed (an object to be detected) located in front thereof, and a breathable dustproof filter 11 detachably mounted to the bottom of the hood 10 by a Velcro (registered trade name) fastener. The visual field of the lens 3 coincides with the wiping range of a wiper (not shown) provided on the front surface of the windshield 1.

The breathable dustproof filter 11 is formed of a high-efficiency particulate air (HEPA) filter having a particle collection efficiency of 99.97% or more for particulates of a 0.3-μm diameter at a rated flow rate, and adapted to collect, for example, cigarette smoke particulates or the like contained in the air in the vehicle compartment 5. The dustproof filter 11 is made of a constituent, such as glass fiber, polytetrafluoroethylene, polyester, polypropylene, or paper.

The camera in the car window having the construction described above images, through the imaging lens 3, an object located in front of the windshield 1. Since the hood 10 is provided with the breathable dustproof filter 11, air is free to move into and out of the hood 10, making it possible to maintain the temperature and humidity inside and outside the hood 10 approximately at the same levels.

Dew may be gathered on the surface of the lens 3 in the hood 10 as well as the windshield 1 under a dewy condition in the vehicle compartment 5; however, the arrangement described above will prevent dew from forming only on the surface of the lens 3 in the hood 10 and the inner surface of the windshield 1 when temperature changes inside or outside the hood 10. If the dew on the surface of the lens 3 must be quickly removed, the breathable dustproof filter 11 may be removed to manually wipe the dew off with cloth or the like.

Furthermore, when the air in the vehicle compartment 5 that contains particulates, such as cigarette smoke particulates, flows into the hood 10, the particulates or the like are collected by the breathable dustproof filter 11, thereby protecting the surface of the lens 3 in the hood 10 and the inner surface of the windshield 1 from contamination.

Accordingly, the camera in the car window makes it possible to photograph an object to be imaged, i.e., an object to be detected, without the danger of dew forming only on the surface of the lens 3 in the hood 10 and on a part of the windshield 1, and without the danger of the surface of the lens 3 in the hood 10 and a part of the windshield 1 being affected by contamination in the vehicle compartment 5.

In addition, the visual field range of the lens 3 coincides with the wiping range of the wiper on the windshield 1, allowing the camera to photograph the object to be imaged without being adversely affected by contamination on the outer surface of the windshield 1.

In the above embodiment, the descriptions have been given of the case where a HEPA film is used as the breathable dustproof filter 10. The present invention, however, is not limited thereto; alternatively, for example, an ultra-low penetration air (ULPA) filter may be used as the breathable dustproof filter. The ULPA filter is an air filter having a particle collection efficiency of 99.9995% or more for particulates of a 0.15-μm diameter at a rated flow rate, and is capable of removing particulates having a diameter of about 0.1 μm that cannot be collected by a HEPA filter.

The descriptions have been given of the case where the camera main body is used as the sensor main body. Alternatively, however, the sensor main body may be, for example, a laser radar.

In addition, the breathable dustproof filter may be secured to the hood.

As described above, a sensor in a car window according to one aspect of the present invention comprises; a hood partitioned in consort with a car window from a vehicle compartment area; and a sensor main body that includes a lens projecting within the hood and detects, through the lens, an object to be detected that is located in front thereof, wherein a breathable dustproof filter is provided on a part of the hood. Therefore, a phenomenon in which dew is formed only on the lens in the hood and on the car window when temperature changes will be prevented, and the lens in the hood and a part of the windshield will be protected from contamination caused by cigarette smoke or other floating particulates. This allows the sensor main body to detect an object with high accuracy.

According to one form of the sensor in a car window, the breathable dustproof filter may be detachably installed to a part of the hood. Hence, if dew is formed on the surface of the lens, the dew can be easily removed from the surface of the lens by hand.

According to another form of the sensor in a car window, the breathable dustproof filter may be a high-efficiency particulate air (HEPA) filter. Hence, the particulates of cigarette smoke in the vehicle compartment can be securely collected, thus protecting the lens from being contaminated by smoke particulates.

According to still another form of the sensor in a car window, the breathable dustproof filter may be an ultra-low penetration air (ULPA) filter. It is possible, therefore, to securely collect particulates having smaller diameters that cannot be collected by a HEPA filter.

According to still another form of the sensor in a car window, the visual field of the lens may coincide with the wiping range of a wiper provided on the front surface of a car window. Hence, an object can be detected without being affected by contamination of the outer surface of a car window.

According to still another form of the sensor in a car window, the sensor main body may be formed of a camera main body. Hence, it possible to photograph an object to be imaged that is located outside a car window.

What is claimed is:

1. A sensor in a car window, comprising:
a hood partitioned in consort with a car window from a vehicle compartment area; and
a sensor main body that includes a lens projecting within the hood and detects, through the lens, an object to be detected that is located in front thereof,
wherein a breathable dustproof filter is provided on a part of the hood.

2. A sensor in a car window according to claim 1, wherein a breathable dustproof filter is detachably installed to a part of the hood.

3. A sensor in a car window according to claim 1, wherein the breathable dustproof filter is a HEPA filter.

4. A sensor in a car window according to claim 1, wherein the breathable dustproof filter is an ULPA filter.

5. A sensor in a car window according to claim 1, wherein the visual field of the lens coincides with the wiping range of a wiper provided on the front surface of the car window.

6. A sensor in a car window according to claim 1, wherein the sensor main body is a camera main body.
